(19) United States
(12) Patent Application Publication
(10) Pub. No.: US 2026/0038073 A1
(43) Pub. Date: Feb. 5, 2026

(54) VEHICLE TERMINAL AND MOBILE TERMINAL FOR IDENTIFYING A DISPATCHED VEHICLE USING AN AUTOMOTIVE LAMP

(71) Applicants: HYUNDAI MOTOR COMPANY, Seoul (KR); KIA CORPORATION, Seoul (KR)

(72) Inventor: Byoung Suk Ahn, Hwaseong-si (KR)

(73) Assignees: HYUNDAI MOTOR COMPANY, Seoul (KR); KIA CORPORATION, Seoul (KR)

(21) Appl. No.: 18/986,425

(22) Filed: Dec. 18, 2024

(30) Foreign Application Priority Data
Jul. 30, 2024 (KR) 10-2024-0100649

(51) Int. Cl. G06Q 50/47; B60Q 1/50; H03M 7/40

(52) U.S. Cl. CPC G06Q 50/47; B60Q 1/543; H03M 7/40; B60Q 2400/40

(57) ABSTRACT

A mobile terminal for identifying a dispatched vehicle using an automotive lamp includes at least one processor and a storage medium storing a computer-readable instruction. When executed by the at least one processor, the computer-readable instruction causes the at least one processor to transmit a vehicle call request including a user identification code, to receive an optical signal output from the vehicle based on the vehicle call request, and to identify whether the vehicle is the dispatched vehicle based on the received optical signal. The optical signal includes the user identification code output through the automotive lamp.

### CROSS-REFERENCE TO RELATED APPLICATION(S)

This application claims the benefit of and priority to Korean Patent Application No. 10-2024-0100649 filed on Jul. 30, 2024 in the Korean Intellectual Property Office, the disclosure of which is incorporated herein by reference in its entirety.

### BACKGROUND

### Technical Field

The present disclosure relates to a vehicle terminal and a mobile terminal for identifying a dispatched vehicle using an automotive lamp.

### Description of Related Art

A vehicle call service is a service for directly connecting a customer who wishes to move with a businessperson who owns a vehicle.

This vehicle call service works in such a way that a caller location may be transmitted to a vehicle driver's smartphone when a caller calls the vehicle by using a smartphone. The vehicle driver may then move the vehicle to the caller location indicated on a map and pick up the caller in the vehicle. The caller may be required to visually confirm a vehicle type, a vehicle number, or the like.

However, the caller may have difficulty in identifying the vehicle number with the naked eye in a region where many vehicles are densely located because a vehicle license plate is located low.

In particular, visibility may be reduced due to headlights at night. The caller may thus have more difficulty in identifying the vehicle number with the naked eye.

### SUMMARY

Aspects of the present disclosure are to provide a vehicle terminal and a mobile terminal for identifying a dispatched vehicle using an automotive lamp that may identify whether a vehicle is the dispatched vehicle from a distance even in a region where many vehicles are densely located or at night and that may eliminate user inconvenience due to flashing of an automotive lamp.

According to an aspect of the present disclosure, a mobile terminal is provided for identifying a dispatched vehicle using an automotive lamp. The mobile terminal includes at least one processor and a storage medium storing a computer-readable instruction. When executed by the at least one processor, the computer-readable instruction causes the at least one processor to transmit a vehicle call request including a user identification code, to receive an optical signal output from the vehicle based on the vehicle call request, and to identify whether the vehicle is the dispatched vehicle based on the received optical signal. The optical signal includes the user identification code output through the automotive lamp.

The at least one processor may: receive the optical signal, which has been by flashing the automotive lamp based on a binary code; demodulate the received optical signal to thus convert the demodulated optical signal into the user identification code; determine whether the converted user identification code matches a pre-stored user identification code; and identify the vehicle as the dispatched vehicle if the converted user identification code matches the pre-stored user identification code as a determination result.

The at least one processor may convert the binary code into the user identification code based on Morse code or American standard code for information interchange (ASCII) code.

The at least one processor may determine whether a user boarding is completed and may output a dispatch completion indication by the mobile terminal if the user boarding is determined to be completed.

The at least one processor may determine that the user boarding is completed when detecting at least one of near field communication (NFC) tagging or quick response (QR) code tagging, or when receiving confirmation from a user.

The at least one processor may activate a vehicle search button when the vehicle approaches within a preset distance from the mobile terminal.

The at least one processor may highlight and display the identified vehicle on a screen when the activated vehicle search button is clicked.

The at least one processor may highlight and output the identified vehicle by surrounding the vehicle with a shape.

According to another aspect of the present disclosure, a vehicle terminal is provided for identifying a dispatched vehicle using an automotive lamp. The vehicle terminal includes at least one processor and a storage medium storing a computer-readable instruction. When executed by the at least one processor, the computer-readable instruction causes the at least one processor to receive dispatch information including a user identification code and to output an optical signal including the user identification code among the dispatch information using the automotive lamp.

The at least one processor may modulate the user identification code to thus convert the modulated user identification code into binary code and may output the optical signal by flashing the automotive lamp based on the generated binary code.

The at least one processor may convert the user identification code into the binary code based on Morse code or American standard code for information interchange (ASCII) code.

The at least one processor may flash the automotive lamp for a binary code “0” to have a shorter turn-on time than a binary code “1,” or the binary code “1” to have a shorter turn-on time than the binary code “0.”

The user identification code may include a combination of letters, symbols, and/or numbers.

The at least one processor may output the optical signal while the vehicle travels.

The at least one processor may output the user identification code through a display device installed on a roof of the vehicle while the vehicle is parked or stopped.

The at least one processor may determine whether a user boarding is completed and may terminate the output of the optical signal when the user boarding is determined to be completed.

The at least one processor may determine that the user boarding is completed when detecting a door opening of the vehicle or receiving the user authentication code.

A frequency at which the automotive lamp flashes may be a frequency at which people do not perceive the flashing. The flashing frequency may be 100 Hz or more.

The automotive lamps may include at least one of a day running light, a low beam, a tail lamp, a position lamp, or a combination of lamps.

### BRIEF DESCRIPTION OF DRAWINGS

The above and other aspects, features, and advantages of the present disclosure should be more clearly understood from the following detailed description, taken in conjunction with the accompanying drawings, in which:

FIG. 1 is a view illustrating an overall system for identifying a dispatched vehicle using an automotive lamp according to an embodiment of the present disclosure;

FIG. 2 is a view illustrating an automotive lamp and a display device according to an embodiment of the present disclosure;

FIGS. 3A and 3B are views illustrating a binary code converted from a user identification code based on Morse code according to an embodiment of the present disclosure;

FIGS. 4A and 4B are views illustrating a binary code converted from the user identification code based on American standard code for information interchange (ASCII) code according to an embodiment of the present disclosure;

FIG. 5 is a view illustrating a process for displaying an identified vehicle when a vehicle search button is clicked according to an embodiment of the present disclosure;

FIG. 6 is a flowchart illustrating a method for identifying a dispatched vehicle using an automotive lamp according to an embodiment of the present disclosure;

FIG. 7 is a flowchart illustrating process S633 in FIG. 6;

FIG. 8 is a flowchart illustrating process S617 in FIG. 6; and

FIG. 9 is a block diagram of a computing device that may fully or partially implement the vehicle terminal and the mobile terminal according to an embodiment of the present disclosure.

### DETAILED DESCRIPTION

Hereinafter, specific embodiments of the present disclosure are described with reference to the accompanying drawings. A detailed description below is provided to facilitate comprehensive understanding of a method, an apparatus, and/or a system, described in the specification. However, the embodiments are only described by way of examples and the present disclosure is not limited thereto.

In describing the embodiments of the present disclosure, a detailed description has been ommitted for a case where it has been decided that the detailed description of the known functions or configurations related to the present disclosure may have unnecessarily obscured the gist of the present disclosure. In addition, terms described below are defined in consideration of their functions in the present disclosure, and may be construed in different ways by intentions of users or operators, practices, or the like. Therefore, the terms should be defined based on the contents throughout the specification. Terms used in the detailed description are merely to describe the embodiments of the present disclosure, and should not be construed to be restrictive. A term of a single number may include its plural number unless explicitly indicated otherwise. It is to be understood that terms “include,” “have,” “comprise,” or the like, and variations thereof, used in the specification specify certain features, numerals, processes, operations, elements, portions, or combinations thereof. Such terms should not be construed to exclude the presence or possibility of one or more other features, numbers, processes, operations, elements, portions, or combinations thereof other than those described.

When a component, device, element, controller, module, or the like (i.e., an apparatus) of the present disclosure is described as having a purpose or performing an operation, function, or the like, the component, device, element, controller, module, or the like should be considered herein as being “configured to” meet that purpose or to perform that operation or function. Each component, device, element, controller, module, or the like, may separately embody or be included with a processor and a memory, such as a non-transitory computer readable media, as part of such an apparatus.

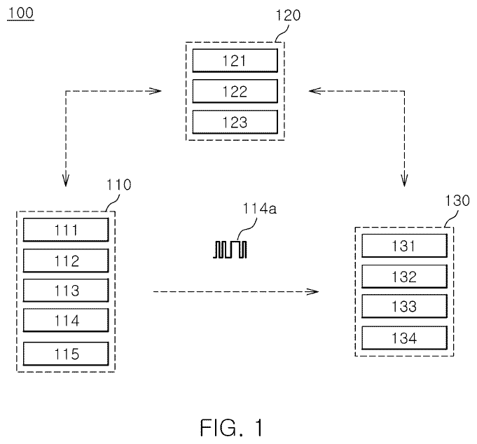

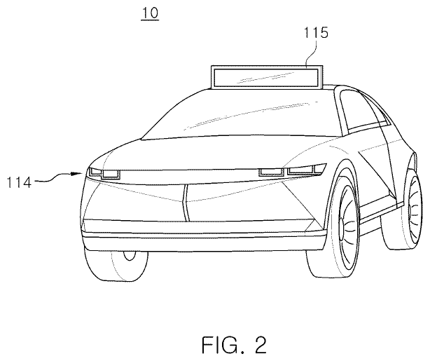

FIG. 1 is a view illustrating an overall system for identifying a dispatched vehicle using an automotive lamp according to an embodiment of the present disclosure. An overall system 100 may include a vehicle terminal 110, a server 120, and a mobile terminal 130. In addition, FIG. 2 is a view illustrating the automotive lamp and a display device according to an embodiment of the present disclosure.

The above-described vehicle terminal 110, server 120, and mobile terminal 130 may each include a processor (for example, a computer, a microprocessor, a central processing unit (CPU), an application-specific integrated circuit (ASIC), or a logic circuit) and a memory for storing software instructions that provide various functions when executed by the processor. The processor and the memory may be implemented as separate semiconductor circuits.

Alternatively, the processor and the memory may be implemented as a single integrated semiconductor circuit.

The processor may include one or more processors.

As shown in FIGS. 1 and 2, the vehicle terminal 110 may be a device disposed in a vehicle 10, and outputting an optical signal 114a including a user identification code among dispatch information. The vehicle terminal 110 may include a control module 111, a storage module 112, a communications module 113, an automotive lamp 114, and a display device 115.

In detail, the control module 111 may receive the dispatch information including the user identification code by using the communications module 113. The control module 111 may output the optical signal 114a including the user identification code by using the automotive lamp 114. The control module 111 may output the optical signal 114a through the automotive lamp 114 while a vehicle 10 travels.

The user identification code described above may be a combination of at least one of letters, symbols, numbers, or various combinations. In addition, the dispatch information may include information such as a vehicle type, a vehicle number, a destination, or a departure point in addition to the user identification code described above.

According to an embodiment of the present disclosure, the control module 111 may modulate the user identification code to thus convert the modulated user identification code into a binary code and may output the optical signal 114a by flashing the automotive lamp 114 based on the generated binary code. A frequency at which the automotive lamp 114 flashes may be a frequency at which people do not perceive the flashing, for example, the frequency may be 100 Hz or more.

In this way, user inconvenience occurring due to the flash may be eliminated by flashing the automotive lamp 114 at the frequency at which people do not perceive the flashing.

In addition, according to an embodiment of the present disclosure, the control module 111 may convert the user identification code into the binary code based on Morse code or ASCII code.

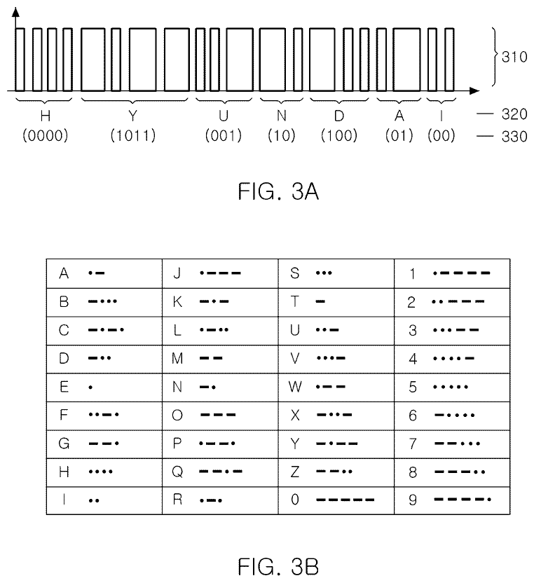

FIGS. 3A and 3B are views illustrating the binary code converted from the user identification code based on Morse code according to an embodiment of the present disclosure. FIG. 3A shows the binary code converted from the user identification code based on Morse code, and FIG. 3B shows a Morse code table.

As shown in FIG. 3A, if the user identification code is “HYUNDAI” (see 320), the control module 111 may convert “HYUNDAI” into the binary codes (0000), (1011), (001), (10), (100), (01), and (00) by referring to the Morse code table shown in FIG. 3B (see 330) and may output the optical signal 114a by flashing the automotive lamp 114 based on a flash signal of the converted binary code (see 310).

In Morse code described above, a long signal (i.e., line) may have a longer lighting time than a short signal (i.e., dot). The long signal may be a binary code “1,” and the short signal may be a binary code “0.” In this case, the binary code “0” may have a shorter turn-on time than the binary code “1.”

According to another embodiment of the present disclosure, the long signal (i.e., line) may have a shorter lighting time than the short signal (i.e., dot). The long signal may be the binary code “0” and the short signal may be the binary code “1.” In this case, the binary code “1” may have a shorter turn-on time than the binary code “0.”

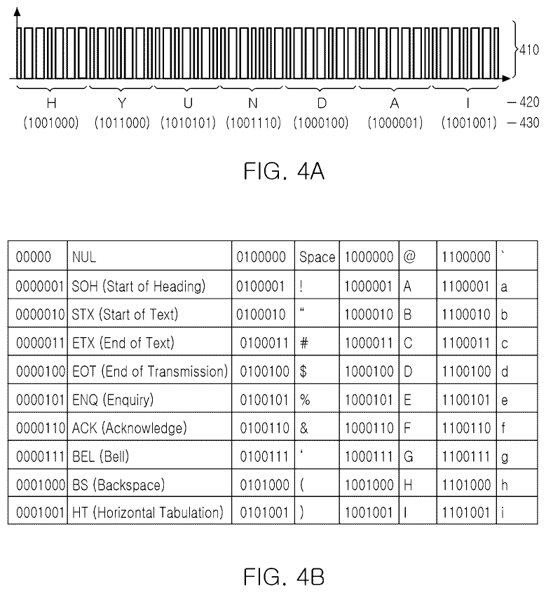

FIGS. 4A and 4B are views illustrating the binary code converted from the user identification code based on American standard code for information interchange (ASCII) code according to an embodiment of the present disclosure. FIG. 4A shows the binary code converted from the user identification code based on ASCII code and FIG. 4B shows an ASCII code table.

As shown in FIG. 4A, if the user identification code is “HYUNDAI” (see 420), the control module 111 may convert “HYUNDAI” into the binary codes (10010000), (1011001), (1010101), (1001110), (1000100), (1000001), and (1001001) by referring to the ASCII code table shown in FIG. 4B (see 430). The control module 111 may output the optical signal 114a by flashing the automotive lamp 114 based on a flash signal of the converted binary code (see 410).

The binary code “0” may have a shorter turn-on time than the binary code “1” based on ASCII code described above. According to another embodiment of the present disclosure, the binary code “1” may have a shorter turn-on time than the binary code “0.”

According to another embodiment of the present disclosure, the control module 111 may output the user identification code through the display device 115 installed on a roof of the vehicle 10 while the vehicle 10 is parked or stopped.

In addition, the control module 111 may determine whether a user boarding is completed, and terminate the output of the optical signal 114a through the automotive lamp 114 or the output of the user identification code through the display device 115 if the user boarding is determined to be completed.

The control module 111 may determine that the user boarding is completed when detecting a door opening of the vehicle 10 or receiving the user authentication code from a user.

The storage module 112 may store various programs for implementing functions performed by the control module 111 described above.

The communications module 113 may transmit and receive various data with the server 120 under control of the control module 111.

The automotive lamp 114 may output the optical signal 114a including the user identification code while the vehicle 10 travels under the control of the control module 111.

The automotive lamps 114 may include at least one of a day running light, a low beam, a tail lamp, a position lamp, or a combination of lamps. For example, at least one of the day running light (DRL) or the tail lamp (TL) may be used during the day. At least one of the low beam (LB), the tail lamp (TL), or the position lamp (PL) may be used at night. The automotive lamps 114 are not necessarily limited thereto. In addition, the shape and location of the automotive lamp 114 may be changed based on a vehicle manufacturer. It should thus be noted that the automotive lamp 114 is not limited to a specific shape or location.

The display device 115 may output the user identification code while the vehicle 10 is parked or stopped under the control of the control module 111. The display device 115 may be, for example, a light emitting diode (LED) device. The display device 115 is not necessarily limited thereto as long as the display device 115 may output the user identification code.

Referring back to FIG. 1, the server 120 may receive a vehicle call request from the mobile terminal 130 and may transmit the dispatch information to the dispatched vehicle. The server 120 may include a control module 121, a storage module 122, and a communications module 123.

In detail, the control module 121 may receive the vehicle call request from the mobile terminal 130, and transmit the dispatch information to the vehicle terminal 110 mounted on the dispatched vehicle.

The storage module 122 may store the various programs for implementing functions performed by the control module 121 described above.

The communications module 123 may transmit and receive the various data with the vehicle terminal 110 and the mobile terminal 130 under the control of the control module 121.

The mobile terminal 130 may receive the optical signal 114a output from the vehicle 10, and identify whether the vehicle 10 is the dispatched vehicle based on the received optical signal 114a. As described above, the above-mentioned optical signal 114a may include the user identification code output through the automotive lamp 114. The mobile terminal 130 may include a control module 131, a storage module 132, a communications module 133, and an input/output module 134.

First, the control module 131 may transmit the vehicle call request including the user identification code to the server 120 through the communications module 133, and receive the optical signal 114a output from the vehicle 10 through the input/output module 134. The vehicle call request may include information such as the user identification code, the destination, or the departure point. The optical signal 114a may be output by flashing the automotive lamp 114 based on the binary code. The control module 131 may then identify the dispatched vehicle 10 based on the received optical signal 114a.

In addition, according to an embodiment of the present disclosure, the control module 131 may demodulate the received optical signal 114a to thus convert the demodulated optical signal into the user identification code. The control module 131 may convert a binary code 330

into a user identification code 320 by referring to the Morse code table (see FIG. 3B) or convert a binary code 430 into a user identification code 420 by referring to the ASCII code table (see FIG. 4B).

The control module 131 may then determine whether the converted user identification code matches a pre-stored user identification code. The control module 131 may identify the vehicle 10 as the dispatched vehicle if the converted user identification code matches the pre-stored user identification code as a determination result.

In addition, according to an embodiment of the present disclosure, the control module 131 may determine whether the user boarding is completed.

In detail, the control module 131 may determine that the user boarding is completed when detecting at least one of near field communication (NFC) tagging or quick response (QR) code tagging, or when receiving confirmation from the user. The control module 131 may detect the NFC tagging through NFC communications between the communications module 113 included in the vehicle terminal 110 and the communications module 133 included in the mobile terminal 130. The control module 131 may detect the QR code tagging by the input/output module 134 included in the mobile terminal 130 capturing the QR code (not shown separately) disposed on the vehicle 10.

The control module 131 may output a dispatch completion indication through the input/output module 134 if the user boarding is determined to be completed as the determination result.

In addition, according to an embodiment of the present disclosure, the control module 131 may output the vehicle identified through the input/output module 134 by highlighting the same.

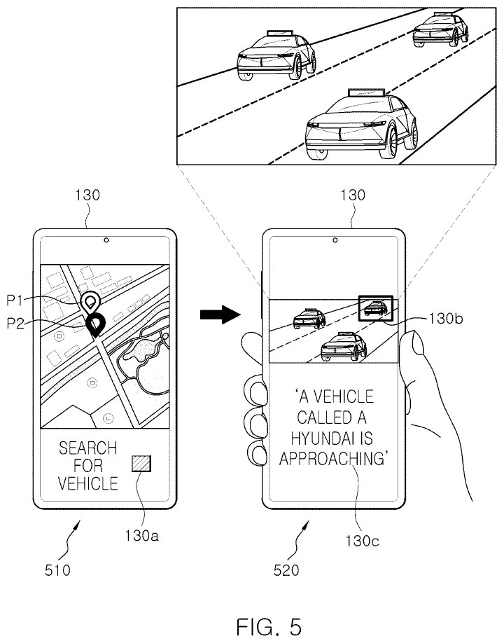

Hereinafter, a process of highlighting and outputting the identified vehicle is described with reference to FIG. 5.

FIG. 5 is a view illustrating a process for displaying the identified vehicle when a vehicle search button is clicked according to an embodiment of the present disclosure.

As shown in FIGS. 1 and 5, the control module 131 may display a current location P2 of the vehicle and a destination location P1. The control module 131 may activate a vehicle search button 130a when the vehicle approaches within a preset distance from the mobile terminal 130 (see 510).

The control module 131 may then highlight and display the identified vehicle on the screen when the activated vehicle search button 130a is clicked (see 520). For example, the control module 131 may highlight and display the identified vehicle by surrounding the vehicle with a shape 130b (e.g., square). Separately, the control module 131 may also display a notification message such as “a vehicle called a HYUNDAI is approaching” (see 130c).

The storage module 132 may store the various programs for implementing the functions performed by the control module 131 described above, the user identification code described above, or the like.

The communications module 133 may transmit and receive the various data with the server 120 under the control of the control module 131.

The input/output module 134 may be a camera for receiving the optical signal 114a output from the vehicle 10 or may be a display device 115 for displaying the current location or destination of the vehicle.

As described above, according to an embodiment of the present disclosure, the vehicle 10 may output the optical signal 114a including the user identification code through the automotive lamp 114 and the user may receive the optical signal 114a through the terminal and identify whether the vehicle 10 is the dispatched vehicle based on the received optical signal 114a, thereby identifying whether the vehicle 10 is the dispatched vehicle from a distance even in a region where many vehicles are densely located or at night.

In addition, according to an embodiment of the present disclosure, the user inconvenience occurring due to the flash may be eliminated by flashing the automotive lamp 114 at the frequency at which people do not perceive the flashing.

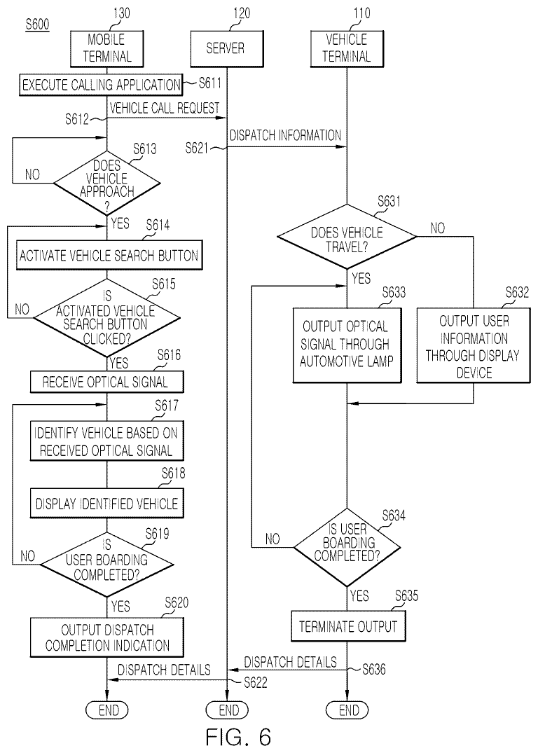

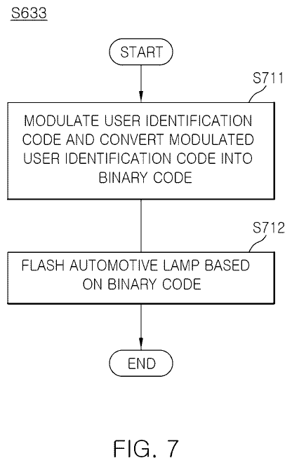

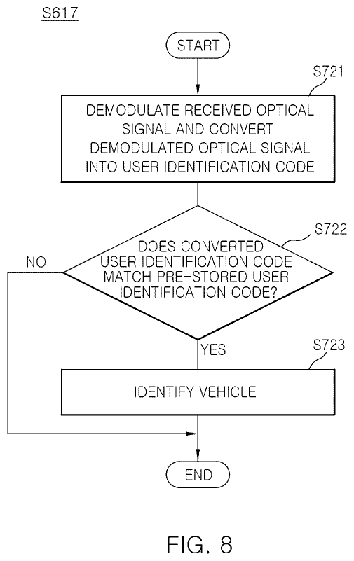

FIG. 6 is a flowchart illustrating a method for identifying a dispatched vehicle using an automotive lamp 114 according to an embodiment of the present disclosure. FIG. 7 is a flowchart illustrating process S633 in FIG. 6. FIG. 8 is a flowchart illustrating process S617 in FIG. 6. Hereinafter, a method (S600) for identifying a

dispatched vehicle using an automotive lamp according to an embodiment of the present disclosure is described with reference to FIGS. 1 through 6. However, to simplify the present disclosure, any redundant descriptions provided with reference to FIGS. 1 through 5 have been omitted.

Referring to FIGS. 1 through 6, the method (S600) for identifying a dispatched vehicle using an automotive lamp according to an embodiment of the present disclosure may start by a process of executing a calling application installed on the mobile terminal 130 (S611).

The mobile terminal 130 may transmit the vehicle call request to the server 120 when receiving the destination, departure point, or the like through the executing calling application (S612). The server 120 may then transmit the dispatch information to the vehicle terminal 110 mounted on the dispatched vehicle 10 (S621). As described above, the vehicle call request may include the information such as the user identification code, the destination, or the departure point. The dispatch information may further include the information such as the vehicle type, the vehicle number, the destination, or the departure point in addition to the user identification code.

The vehicle terminal 110 may then determine whether the vehicle 10 travels (S631).

The vehicle terminal 110 may output the user identification code through the display device 115 installed on the roof of the vehicle 10 (S632) if the vehicle 10 does not travel, i.e., while the vehicle 10 is parked or stopped as a determination result in process S631.

On the other hand, the vehicle terminal 110 may output the optical signal 114a through the automotive lamp 114 (S633) if the determination result in process S631 indicates that the vehicle 10 travels. The optical signal 114a described above may include the user identification code, and the user identification code may include a combination of at least one of letters, symbols, or numbers.

In detail, as shown in FIG. 7, the vehicle terminal 110 may modulate the user identification code to thus convert the modulated user identification code into the binary code (S711). The vehicle terminal 110 may output the optical signal 114a by flashing the automotive lamp 114 based on the generated binary code (S712). As described above, the frequency at which the automotive lamp 114 flashes may be a frequency at which people do not perceive the flashing. For example, the frequency may be 100 Hz or more.

In addition, according to an embodiment of the present disclosure, as described above, the vehicle terminal 110 may convert the user identification code into the binary code based on Morse code or ASCII code.

The vehicle terminal 110 may then determine whether the user boarding is completed (S634).

As described above, the vehicle terminal 110 may determine that the user boarding is completed when detecting a door opening of the vehicle 10 or receiving the user authentication code from the user.

The vehicle terminal 110 may terminate the output (S635) if the user boarding is determined to be completed as a determination result in process S634. The vehicle terminal 110 may terminate the output of the optical signal 114a through the automotive lamp 114 or the output of the user identification code through the display device 115.

The vehicle terminal 110 may then transmit dispatch details to the server 120, and the server 120 may transmit the same to the mobile terminal 130. The dispatch details may include the user identification code, the vehicle type, the departure point, the destination, or the like.

The mobile terminal 130 may determine whether the vehicle approaches after transmitting the vehicle call request to the server 120 (S613).

The mobile terminal 130 may activate the vehicle search button 130a (S614) when the vehicle 10 is determined to approach within the preset distance from the mobile terminal 130 as a determination result in process S613.

The mobile terminal 130 may then determine whether the activated vehicle search button 130a is clicked (S615).

The mobile terminal 130 may receive the optical signal 114a when the vehicle search button 130a is clicked as a determination result in process S615 (S616), identify the vehicle 10 based on the received optical signal 114a (S617), and then display the identified vehicle (S618).

In detail, as shown in FIG. 8, the mobile terminal 130 may demodulate the received optical signal 114a to thus convert the demodulated optical signal 114a into the user identification code (S721) and then may determine whether the converted user identification code matches the pre-stored user identification code (S722). The mobile terminal 130 may identify the vehicle 10 as the dispatched vehicle if the converted user identification code matches the pre-stored user identification code as a determination result in process S722.

According to an embodiment of the present disclosure, the mobile terminal 130 may highlight and display the identified vehicle on the screen. For example, as described above, the mobile terminal 130 may highlight and display the identified vehicle by surrounding the same with a shape 130b (e.g., square). Separately, as described above, the mobile terminal 130 may also display the notification message such as “a vehicle called a HYUNDAI is approaching” (see 130c).

The mobile terminal 130 may then determine whether the user boarding is completed (S619).

According to an embodiment of the present disclosure, as described above, the mobile terminal 130 may determine that the user boarding is completed when detecting at least one of the NFC tagging or the QR code tagging, or when receiving confirmation from the user.

The mobile terminal 130 may output the dispatch completion indication (S620) if the user boarding is determined to be completed as the determination result in process S619.

As described above, according to an embodiment of the present disclosure, the vehicle 10 may output the optical signal 114a including the user identification code through the automotive lamp 114 and the user may receive the optical signal 114a through the terminal and identify whether the vehicle 10 is the dispatched vehicle based on the received optical signal 114a, thereby identifying whether the vehicle 10 is the dispatched vehicle from a distance even in the region where many vehicles are densely located or at night.

In addition, according to an embodiment of the present disclosure, the user inconvenience occurring due to the flash may be eliminated by flashing the automotive lamp at the frequency at which people do not perceive the flashing.

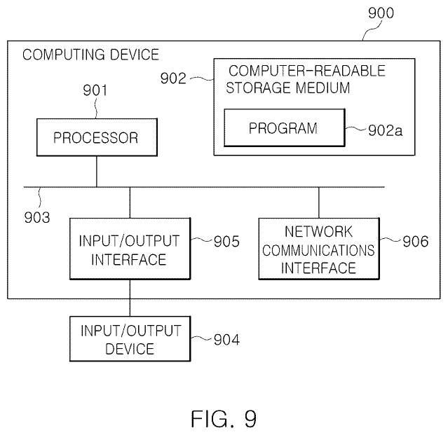

FIG. 9 is a block diagram of a computing device 900 that may fully or partially implement the vehicle terminal 110, the server 120, and the mobile terminal 130 according to an embodiment of the present disclosure.

As shown in FIG. 9, the computing device 900 may include at least one processor 901, a computer-readable storage medium 902, and a communications bus 903.

The processor 901 may cause the computing device 900 to be operated according to the embodiments described above. For example, the processor 901 may execute one or more programs stored in the computer-readable storage medium 902. One or more programs may include one or more computer-executable instructions. The computer-executable instructions may cause the computing device 900 to perform the operations according to then embodiments, when executed by the processor 901.

The computer-readable storage medium 902 may store the computer-executable instructions or program codes, program data, and/or other suitable form of information. A program 902a stored in the computer-readable storage medium 902 may include a set of instructions executable by the processor 901. In an embodiment, the computer-readable storage medium 902 may be a memory (for example, a volatile memory such as a random access memory, a non-volatile memory, or a suitable combination thereof), at least one magnetic disk storage device, an optical disk storage device, a flash memory device, any other type of storage medium capable of being accessed by the computing device 900 and storing desired information, or a suitable combination thereof.

The communications bus 903 may interconnect various other components of the computing device 900, including the processor 901 and the computer-readable storage medium 902.

The computing device 900 may also include one or more input/output interfaces 905 and one or more network communications interfaces 906 that provide interfaces for one or more input/output devices 904. The input/output interface 905 and the network communications interface 906 may be connected to the communications bus 903. A network may be a cellular network such as global system for mobile communications (GSM), enhanced data rates for GSM evolution (EDGE), general packet radio service (GPRS), code division multiple access (CDMA), time division-CDMA (TD-CDMA), universal mobile telecommunications system (UMTS), long term evolution (LTE), or another cellular network. In addition, the network communications interface 906 may further include near field communication (NFC), which is one of wireless tag technologies.

The input/output device 904 may be connected to other components of the computing device 900 through the input/output interface 905. The input/output device 904 may include an input device such as a pointing device (e.g., mouse or trackpad), a keyboard, a touch input device (e.g., touchpad or touchscreen), a voice or sound input device, various types of sensor devices, and/or a camera, and/or an output device such as the display device, a printer, a speaker, and/or a network card. The input/output device 904 may be disposed in the computing device 900 as a component included in the computing device 900, or may be connected to the computing device 900 as a separate device distinct from the computing device 900.

The embodiments of the present disclosure may include a program for executing the methods described herein on a computer and a computer-readable recording medium including the program. The computer-readable recording medium may include a program instruction, a local data file, a local data structure, or the like, either alone or in combination. The medium may be specifically designed and configured for the present disclosure, or may be commonly available in a computer software field. An example of the computer-readable recording medium may include: a magnetic medium such as a hard disk, a floppy disk, or a magnetic tape; an optical recording medium such as a compact disk read only memory (CD-ROM) or a digital versatile disk (DVD); or a hardware device specifically storing and executing a program instruction such as a read only memory (ROM), a random access memory (RAM), or a flash memory. An example of the program may include a high-level language code executable by the computer using an interpreter, or the like, as well as a machine language code made by a compiler.

As set forth above, according to the embodiments of the present disclosure, the vehicle may output the optical signal including the user identification code through the automotive lamp and the user may receive the optical signal through the terminal and identify whether the vehicle is the dispatched vehicle based on the received optical signal, thereby identifying whether the vehicle is the dispatched vehicle from a distance even in the region where many vehicles are densely located or at night.

In addition, according to an embodiment of the present disclosure, the user inconvenience occurring due to the flash may be eliminated by flashing the automotive lamp at the frequency at which people do not perceive the flashing.

While embodiments have been shown and described above, it should be apparent to those having ordinary skill in the art that modifications and variations could be made without departing from the scope of the present disclosure as defined by the appended claims.

What is claimed is:

1. A mobile terminal for identifying a dispatched vehicle using an automotive lamp, the mobile terminal comprising:
at least one processor; and
a storage medium storing a computer-readable instruction,
wherein when executed by the at least one processor, the computer-readable instruction causes the at least one processor to
transmit a vehicle call request including a user identification code,
receive an optical signal output from a vehicle based on the vehicle call request, and
identify whether the vehicle is the dispatched vehicle based on the received optical signal,
wherein the optical signal includes the user identification code output through the automotive lamp.

2. The mobile terminal according to claim 1, wherein the at least one processor:
receives the optical signal, the optical signal being output by flashing the automotive lamp based on binary code;
demodulates the received optical signal and converts the demodulated optical signal into the user identification code;
determines whether the converted user identification code matches a pre-stored user identification code; and
identifies the vehicle as the dispatched vehicle when the converted user identification code matches the pre-stored user identification code as a determination result.

3. The mobile terminal according to claim 2, wherein the at least one processor converts the binary code into the user identification code based on Morse code or American standard code for information interchange (ASCII) code.

4. The mobile terminal according to claim 1, wherein the at least one processor:
determines whether a user boarding is completed; and
outputs a dispatch completion indication if the user boarding is determined to be completed.

5. The mobile terminal according to claim 4, wherein the at least one processor determines that the user boarding is completed when detecting at least one of near field communication (NFC) tagging or quick response (QR) code tagging, or when receiving confirmation from a user.

6. The mobile terminal according to claim 1, wherein the at least one processor activates a vehicle search button when the vehicle approaches within a preset distance from the mobile terminal.

7. The mobile terminal according to claim 6, wherein the at least one processor highlights and displays an identified vehicle on a screen when the activated vehicle search button is clicked.

8. The mobile terminal according to claim 7, wherein the at least one processor highlights and outputs the identified vehicle by surrounding the vehicle with a shape.

9. A vehicle terminal for identifying a dispatched vehicle using an automotive lamp, the vehicle terminal comprising:
at least one processor; and
a storage medium storing a computer-readable instruction,
wherein, when executed by the at least one processor, the computer-readable instruction causes the at least one processor to
receive dispatch information including a user identification code, and
output an optical signal including the user identification code among the dispatch information using the automotive lamp.

10. The vehicle terminal according to claim 9, wherein the at least one processor:
modulates the user identification code and converts the modulated user identification code into a binary code, and
outputs the optical signal by flashing the automotive lamp based on the generated binary code.

11. The vehicle terminal according to claim 10, wherein the at least one processor converts the user identification code into the binary code based on Morse code or American standard code for information interchange (ASCII) code.

12. The vehicle terminal according to claim 10, wherein the at least one processor flashes the automotive lamp for a binary code “0” to have a shorter turn-on time than a binary code “1,” or the binary code “1” to have a shorter turn-on time than the binary code “0.”

13. The vehicle terminal according to claim 9, wherein the user identification code includes at least one of a combination of letters, symbols, and/or numbers.

14. The vehicle terminal according to claim 9, wherein the at least one processor outputs the optical signal while the vehicle travels.

15. The vehicle terminal according to claim 9, wherein the at least one processor outputs the user identification code through a display device installed on a roof of the vehicle while the vehicle is parked or stopped.

16. The vehicle terminal according to claim 9, wherein the at least one processor:
determines whether a user boarding is completed; and
terminates the output of the optical signal when the user boarding is determined to be completed.

17. The vehicle terminal according to claim 16, wherein the at least one processor determines that the user boarding is completed when detecting a door opening of the vehicle or when receiving the user authentication code.

18. The vehicle terminal according to claim 10, wherein a frequency at which the automotive lamp flashes is a frequency at which people do not perceive the flashing.

19. The vehicle terminal according to claim 18, wherein the flashing frequency is 100 Hz or more.

20. The vehicle terminal according to claim 9, wherein the automotive lamps includes at least one of a day running light, a low beam, a tail lamp, a position lamp, or any combination thereof.
